(19) United States
(12) Patent Application Publication
(10) Pub. No.: US 2004/0117262 A1
(43) Pub. Date: Jun. 17, 2004

(54) System and method for conducting a monetary transaction

(76) Inventors: Jeffrey Keith Berger, Palatine, IL (US); Alson Lee, Inverness, IL (US)

Correspondence Address: MOTOROLA INC, 600 NORTH US HIGHWAY 45, ROOM AS437, LIBERTYVILLE, IL, 60048-5343, US

(21) Appl. No.: 10/321,902

(22) Filed: Dec. 17, 2002

(51) Int. Cl. G06F 17/60

(52) U.S. Cl. 705/16

(57) ABSTRACT

There is provided a system and method for conducting a monetary transaction among a Point-Of-Purchase (“POP”) device (102), a mobile device (104) and a certifying authority (108). The POP device (102) may provide goods and/or services. A short-range wireless link (110) is established between the POP device (102) and the mobile device (104), and a long-range wireless link (112) is established between the mobile device and the certifying authority (108). The POP device (102) provides its identity and prices for its goods/services to the mobile device (104). After a particular good/service is selected, the mobile device (104) provides its identity and certain information, namely the POP device's identity and the price for the selected good/service, to the certifying authority (108). The POP device (102) then receives the certain information back from the certifying authority (108) via the mobile device (104) as well as an associated digital signature generated by the certifying authority. If the digital signature is authenticated, the POP device (102) dispenses the selected good/service.

### FIELD OF THE INVENTION

The present invention relates generally to the field of payment mechanisms, other than cash, for conducting monetary transactions. In particular, the field of this invention relates to Point-Of-Purchase (“POP”) devices having wireless communication capabilities for electronic payment of goods and/or services.

### BACKGROUND OF THE INVENTION

POP devices may use payment mechanisms other than cash. Such POP devices generally require secure application modules or wide area communication channels to support cashless transactions. In particular, a POP device includes secret key technology issued by a financial authorization system to guarantee the transaction. The secret key technology is used in the mutual authentication process with the payment means and is integral to the transaction. The POP device must include protection mechanisms to protect the secret key technology from discovery, thus adding significant cost to the manufacture of the machine. Also, the POP device includes a “back channel” to a financial authorization system, thus adding significant cost to the manufacture and operation of the machine. Unfortunately, the cost of implementing these relatively expensive components significantly raises the cost of manufacturing and operating POP devices that use alternative payment mechanisms.

Accordingly, there is a need for an alternative payment system for POP devices that does not require special security measures. There is a further need for an alternative payment system for POP devices that utilize relatively inexpensive communication technology and, thus, do not require expensive wide area communication components.

### BRIEF DESCRIPTION OF THE DRAWINGS

FIG. 1 is a perspective view of a preferred embodiment in accordance with the present invention.

FIG. 2 is a block diagram representing the POP device of FIG. 1.

FIG. 3 is a block diagram representing the mobile device of FIG. 1.

FIG. 4 is a block diagram representing the certifying authority of FIG. 1.

FIG. 5 is a flow diagram representing a preferred operation of the POP device of FIG. 2.

FIG. 6 is a flow diagram representing a preferred operation of the mobile device of FIG. 3.

FIG. 7 is a flow diagram representing a preferred operation of the certifying authority of FIG. 4.

### DETAILED DESCRIPTION OF THE PREFERRED EMBODIMENT

The present invention is a system and method for conducting monetary transactions with Point-Of-Purchase (“POP”) devices. The system and method minimizes the cost of manufacturing and/or operating POP devices by minimizing security measures required by the machines and by including relatively inexpensive communication technology within the machines. In particular, public key information is solely used and stored by the POP devices instead of both public and private key information. Possession of both public and private key information is quite valuable, whereas possession of just public key information is nominal in value. POP devices that only utilize public key information require significantly less protection than POP devices that utilize public and private key information and, thus, cost significantly less to manufacture. Also, the POP devices use relatively inexpensive short-range communication technology instead of more expensive wide area communication technology, thus, cost significantly less to manufacture and operate.

The present invention is a method for a mobile device of conducting a monetary transaction between a POP device and a certifying authority. A first communication is established with the POP device, and a POP device identification and an amount are received from the POP device. Also, a second communication is established with the certifying authority, and the POP device identification, the amount, and a mobile device identification are transmitted to the certifying authority. The POP device identification, the amount, and a digital signature are then received from the certifying authority and forwarded to the POP device.

The present invention is also a method for a POP device of conducting a monetary transaction between a mobile device and a certifying authority. A communication is established with the mobile device, and a POP device identification and an amount are sent to the mobile device. The POP device identification, the amount, and a digital signature, provided by the certifying authority, are then received from the mobile device. Thereafter, one or more goods and/or notifications of service are dispensed.

The present invention is further a system for conducting a monetary transaction that comprises a POP device, a mobile device, and a certifying authority. The POP device has a first transceiver and is configured to generate information including a POP device identification and an amount. The mobile device is associated with a mobile device identification, and the mobile device has a second transceiver configured to communicate with the first transceiver of the POP device and a third transceiver configured to communicate with a remote device. The second transceiver receives the information from the POP device. The certifying authority has a fourth transceiver being configured to communicate with the third transceiver of the mobile device. The fourth transceiver receives the information and the mobile device identification from the mobile device and transmits the information and a digital signature to the mobile device. The mobile device forwards the information and the digital signature to the POP device.

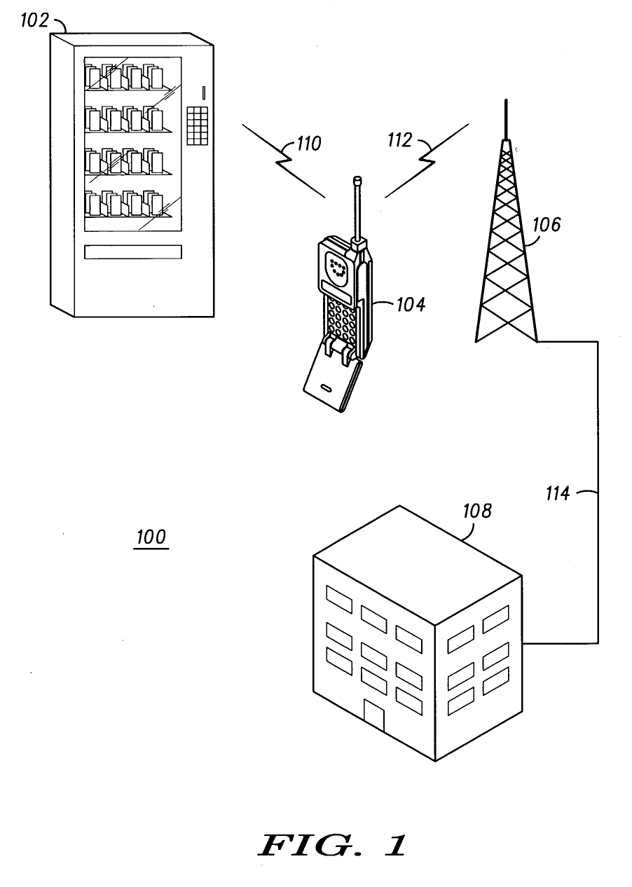

Referring to FIG. 1, there is shown a block diagram illustrating an electronic transaction system 100 in accordance with a preferred embodiment of the present invention. The system includes a Point-Of-Purchase (“POP”) device 102, a mobile device 104, a communication network 106 and a certifying authority 108. The POP device 102 may dispense goods such as consumer and commercial products, services such as power and product delivery, or both. For example, the present invention is equally applicable for enabling services transactions, such as pre-paid electric meter authorizations, as well as goods transactions. Communication between the POP device 102 and the mobile device 104 occurs via a short-range wireless link 110, and communication between the mobile device and the communication network 106 occurs via a longer-range wireless link 112. Unlike the short-range and longer-range wireless links 110, 112, communication between the communication network 106 and the certifying authority 108 may be any type of wired connection, wireless connection, or combination wired/wireless and is represented by network link 114.

The POP device 102, the mobile device 104, the communication network 106 and the certifying authority must have data communication capabilities and may, optionally, include voice communication capabilities. For the preferred embodiment, the mobile device 104 is a radiotelephone that includes both voice and data communication capabilities and the communication network 106 is a telecommunications network that communicates voice and data information with the mobile device. Examples of the mobile device 104 include, but are not limited to, radiotelephones, paging devices, personal digital assistants, portable computing devices, and the like, having wireless communication capabilities.

The POP device 102 requires utilization of short-range wireless technology, the mobile device 104 requires utilization of short-range and longer-range wireless technology, and the communication network 106 requires utilization of longer-range wireless technology. Examples of short-range wireless technology that may be used by the POP devices 102 and the mobile device 104 for short-range wireless link 110 include, but are not limited to, Bluetooth, Wi-Fi (i.e., IEEE 802.11a, 802.11b and 802.11g), HomeRF, proprietary RF communications, and infrared communications. Examples of longer-range wireless technology that may be used by the mobile device 104 and the communication network 106 for longer-range wireless link 112 include, but are not limited to, standard cellular protocols such as analog, CDMA, GSM, TDMA, UMTS, and paging protocols such as FLEX and REFLEX.

The longer-range wireless link 112 has a longer range of communication than the short-range wireless link 110. A direct link is established between the mobile device 104 and the POP device 102 when establishing the short-range wireless link 110, and an indirect link is established between the mobile device and the certifying authority 108 when establishing the longer-range wireless link 112. In other words, an ad hoc link operable within a particular range from the POP device 102 is established when the short-range wireless link 110 is established, and a network link is established between the mobile device 104 and a location remote from the POP device when the longer-range wireless link 112 is established.

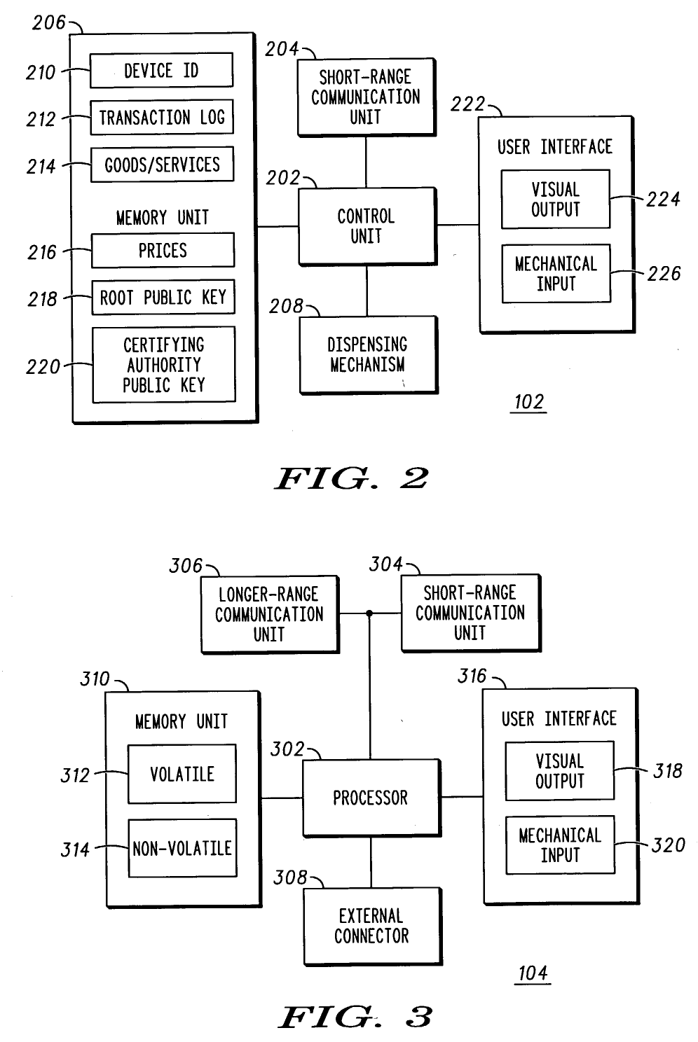

Referring to FIG. 2, there is shown representative components of the Point of Purchase (“POP”) device 102. It should be understood that two or more components may be combined or one or more components may be separated into multiple components so long as the device 102 is capable of its primary functions as described herein. The POP device 102 includes a control unit 202 for general operation of the device 102, such as communicating with other components of the device, as well as calculating hash values and signatures of received messages. In the alternative, the function of calculating hash values and signatures may be performed by a separate component or one of the other components shown in FIG. 2.

The POP device 102 also includes a short-range transceiver or communication unit 204 for communication with an external entity, a memory unit 206 having non-volatile memory, and a dispensing mechanism 208. The short-range communication unit 204 communicates with similar short-range communication units of other devices, such as the mobile device 104. The dispensing mechanism 208 is capable of releasing an item, i.e., goods, or notification of a service when authorized by the control unit 202.

The non-volatile memory of the memory unit 206 may maintain a POP device identification (“ID”) 210, a transaction log 212, a list of purchasable items and/or services 214, prices of the items and/or services 216, and one or more public keys 218, 220. The POP device ID 210 is a specific code distinguishes the POP device 102 from other POP devices, the transaction log 212 is an electronic record of all transactions that occur at the POP device, the list of purchasable items and/or services 214 identifies all goods and/or services that are available for purchase at the POP device, and the prices of items and/or services 216 provides a specific selling price for each item and/or service identified by the list of purchasable items and/or services. The control unit 202 uses one or both public keys 218, 220 to decrypt information received from a remote location that has been encrypted using a private key corresponding to the public key. It is important to note that the POP device 102 only includes public keys that, unlike devices that include both public and private keys, do not require special tamper protection mechanisms. The POP device 102 provides a purchase request message to the mobile device 104 via the short-range wireless link 110 that includes a POP device ID corresponding to the POP device, a list of items and/or services available for purchase and prices associated with the items and/or services available for purchase.

Optionally, the POP device 102 may also include a user interface 222. The user interface 222 may be used to provide access for a cash transaction or to supplement the user interface of the mobile device 104. For the preferred embodiment, the user interface 222 includes a visual output 224 and a mechanical input 226, such as a display and a keypad, respectively.

Referring to FIG. 3, there is shown representative components of the mobile device 104. Similar to the POP device 102, two or more components of the mobile device 104 may be combined or one or more components may be separated into multiple components. The mobile device 104 includes a processor 302 for general operation of the device, such as communicating with other components of the device. The mobile device 104 is a device separate from the POP device 102 that serves to forward information received from the POP device to the certifying authority 108 via the communication network 106 and forward certain information received from the certifying authority to the POP device. The mobile device 104 may also supplement any information that it forwards, such as adding a mobile device identification (“ID”) corresponding to the mobile device, a selection of goods or services available from the POP device 102, the prices associated with each selection, and/or total amount due. As such, the POP device 102 only requires relatively inexpensive short-range communication technology for communication with the mobile device 104 instead of more expensive wide area communication technology for communication with the certifying authority 108.

The mobile device 104 may perform other functions in addition to communicating between the POP device 102 and the certifying authority 108. For example, for the preferred embodiment, the mobile device 104 is a radiotelephone having a cellular communication capability and a Bluetooth communication capability. Accordingly, the preferred embodiment is capable of general voice and data communication with a wide variety of destinations via a telecommunications network as well as voice and data communication with a wide variety of devices within a local communication area via an ad hoc or peer-to-peer network.

The mobile device 104 includes a short-range transceiver or communication unit 304 for communication with the POP device 102, and a longer-range transceiver or communication unit 306 for communication with the certifying authority 108 via the communication network 106. For an alternative embodiment, the mobile device 104 may include an external connector 308 for receiving a removable module, such as a smart card, to communicate with the POP device 104 and/or the certifying authority 108. The short-range communication unit 304 communicates with similar short-range communication units of other devices, such as the short-range communication unit 204 of the POP device 102. The longer-range communication unit 306 communicates with similar longer-range communication units of other devices, such as a base station of the communication network 106.

The mobile device 104 may also includes a memory unit 310 having volatile memory 312 and non-volatile memory 314 and a user interface 316 having a visual output 318 and a mechanical input 320. The non-volatile memory 314 of the memory unit 310 may maintain a mobile device ID, which is a specific code that distinguishes the mobile device 104 from other devices. It should be noted that the memory unit 308, or a portion thereof, may be directly coupled to the processor 302, integrated in the processor, or coupled to the external connector 308 of the mobile device 104 as a removable module, such as a smart card. The user interface 316 provides interaction of a user with the mobile device 104 as well as any device that communicates with the mobile device, but is not required for communicating information between the POP device 102 and the certifying authority 108. For the preferred embodiment, the user interface 316 includes a visual output 318 and a mechanical input 320, such as a, display and a keypad, respectively.

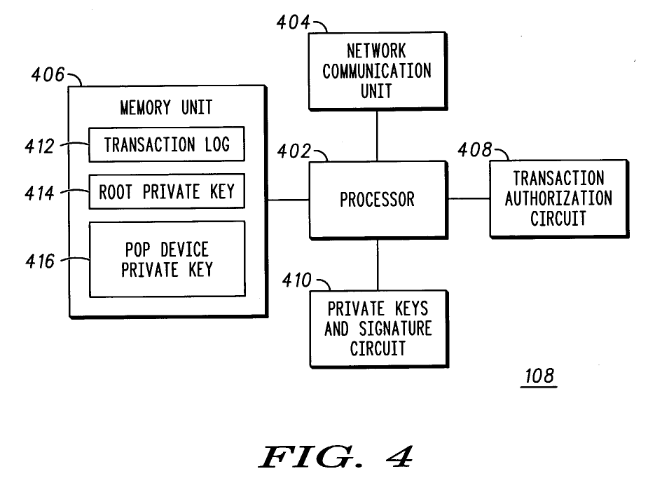

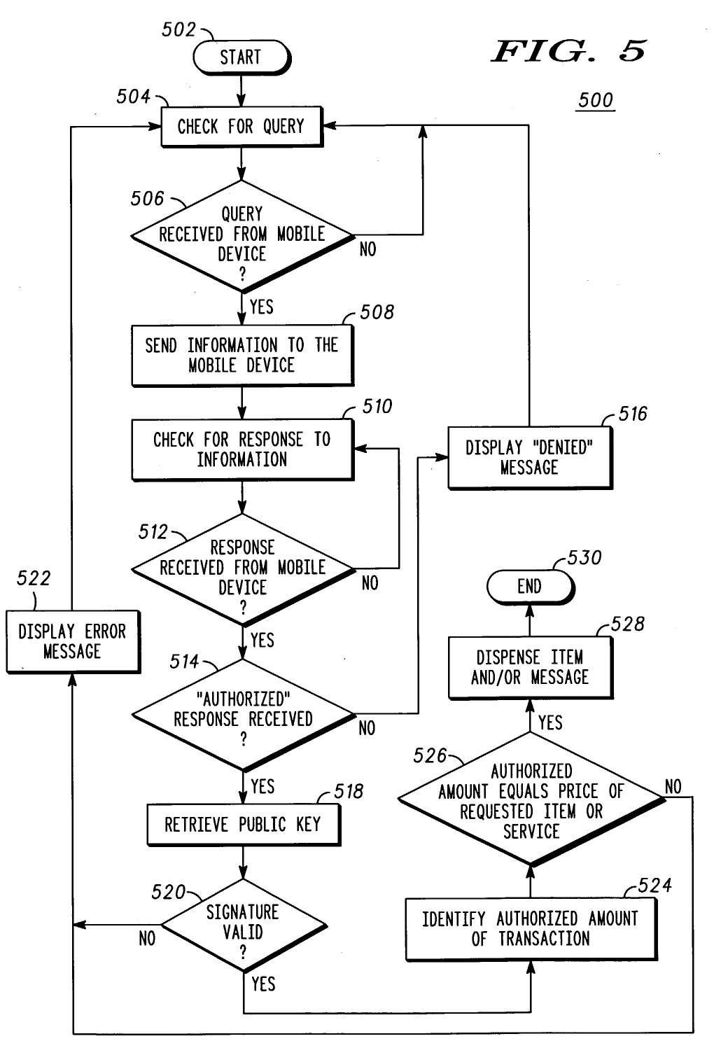

Referring FIG. 4, there is shown representative components of the certifying authority 108. Similar to the POP device 102 and the mobile device 104, two or more components of the certifying authority 108 may be combined or one or more components may be separated into multiple components. The certifying authority 108 includes a processor 402 for general operation of the authority, such as communicating with other components of the authority. The certifying authority 108 is located remote from the POP device 102, but the exact location of the certifying authority is not important so long as it communicates with a communication network 106 and, in turn, communicates with the mobile device 104. Accordingly, the certifying authority 108 includes a network transceiver or network communication unit 404 for communication with a plurality of entities, including the mobile device 104, via the communication network 106.

The certifying authority 108 is, or has a business relationship with, the operator of the POP device 102. The certifying authority 108 may have the capability of verify the authenticity of the mobile device 104, transfer funds between a financial account associated with the mobile device and the operator of the POP device 102, and digitally sign authorizing transactions used in the dispensing products and/or services. The certifying authority 108 may be any of several parties acting in the role of financial authorization and clearing. Examples of such entities include, but are not limited to, a cellular system operator, a financial institution and a POP device operator.

The certifying authority 108 also includes a memory unit 406 having non-volatile memory, a transaction authorization circuit 408 and a private keys and signature circuit 410. The non-volatile memory of the memory unit 406 may maintain a transaction log 412 and one or more private keys 414, 416. The certifying authority 108 may also include public keys, but such public keys are not utilized for the present invention. The transaction log 412 is an electronic record of all transactions that are processed by the certifying authority 108. The processor 402 uses each private key 414, 416 to encrypt information destined for the POP device 102 so that the POP device may decrypt the information using a public key corresponding to the private key.

The transaction authorization circuit 408 authorizes the financial transaction and the private keys and signature circuit 410 digitally signs the financial transaction. It is to be understood that the transaction authorization circuit 408 and/or the private keys and signature circuit 410 may be separate components from the processor 402, integrated together within a single circuit, or integrated with the processor 402. The transaction authorization circuit 408 performs operations related to the purchase transaction such as, for example, identifying the mobile device 104, authorizing the request for purchase received from the POP device 102, and creating/appending a financial transaction record in the memory unit 406. The transaction authorization circuit 408 provides purchase authorization message that includes a purchase amount, a POP device ID corresponding to the POP device 102, and a sequence number. Optionally, the purchase authorization message may also include the item(s) or service(s) being purchased. The sequence number is included in the purchase authorization message to prevent replaying the same transaction at a later time. The sequence number may be generated by one of the components of the certifying authority 108, such as the processor 402, the transaction authorization circuit 408, or the private keys and signature circuit 410.

The private keys and signature circuit 410 processes the purchase authorization message to generate a hash value, and signs the hash value via public key cryptography using a secret or private key 414, 416 known only to the certifying authority 108. The signed purchase authorization message is transmitted from the network communication unit 404 to the mobile device 104 via the communication network 106 and forwarded by the mobile device to the POP device 102.

Referring to FIG. 5, there is shown a flow diagram representing a preferred operation 500 of the POP device 102. The preferred operation 500 of the POP device 102 begins at step 502 and, POP device monitors for any mobile devices within a proximity of the POP device. In particular, the control unit 202 of the POP device 102 checks for any query received by the short-range communication unit 204 from a short-range communication unit 304 of a mobile device 104 within the proximity via the short-range wireless link 110 at step 504. The proximity is limited by a maximum range of point-to-point transmission of the short-range wireless link 110. If a query is not received initially, then the control unit 202 continues the check for any query multiple times, if necessary, at step 506. The query is a request for information that includes a POP device ID, available items and/or services, corresponding prices of such items and/or services, and the uniform resource locator (“URL”) or phone number of an appropriate certifying authority 108.

If a query is received from a mobile device 104 via short-range wireless link 110, then the control unit 202 retrieves the information from the memory unit 206 and directs the short-range communication unit 204 to send the information to the mobile device 104 via the short-range wireless link 110 at step 508. The short-range communication unit 204 then checks for a response to the information from the mobile device 104 at step 510, and continues to check for a response at step 512. When the short-range communication unit 204 receives the response to the information, the control unit 202 may analyze the response to determine whether the response provides authorization for any type of transaction for the POP device's goods and/or services has been received from the certifying authority 108 at step 514. The control unit 202 may determine whether authorization is provided by a wide-variety of methods. For example, the control unit 202 may determine that the authorization has been provided if the response to the information includes header data that so indicates, if the signature so indicates, or if the response to the information is not signed. In the alternative, the control 202 may determine whether authorization is provided after the response to the information has been decrypted if authorization status is included within the signature. If an “authorized” response is not received (i.e., a “denied” response is received), then the visual output 224 of the POP device 102, the visual output 318 of the mobile device 104, or both, will provide an appropriate “denied” message at step 516.

If an “authorized” response to the information is received, then the control unit 202 retrieves the public key from memory unit 206 to decrypt the response at step 518. The POP device 102 uses a public key to decrypt the message signature of the response and compare against a locally generated signature or hash. The control unit 202 then determines whether the signature of the response is valid at step 520. If the signature is not valid, then visual output 224 of the POP device 102, the visual output 318 of the mobile device 104, or both, provides an error message at step 522.

For the preferred embodiment, the POP device 102 does not have any means to provide change for any difference between amounts paid by a purchaser and amounts due by the purchaser in order to minimize the cost of manufacturing the POP device 102. Therefore, the amount authorized by the certifying authority 108 must equal the price of the requested item(s) and/or service(s). Thus, if the signature is valid, then the control unit 202 identifies from the decrypted response the amount authorized for the transaction by the certifying authority 108 at step 524. If, at step 526, the authorized amount does not equal the price of the requested item(s) and/or service(s), then the visual output 224 of the POP device 102, the visual output 318 of the mobile device 104, or both, provides an error message at step 522. If the authorized amount equals the price of the requested item(s) and/or service(s), then the dispensing mechanism 208 dispenses the appropriate item(s) and/or message regarding the purchased service(s) at step 528. Optionally, the control unit 202 may write the transaction information to log file in the memory unit 310. Finally, the control unit 202 terminates the operation 500 at step 530, at which point, the control unit may return to the beginning of the operation at step 502.

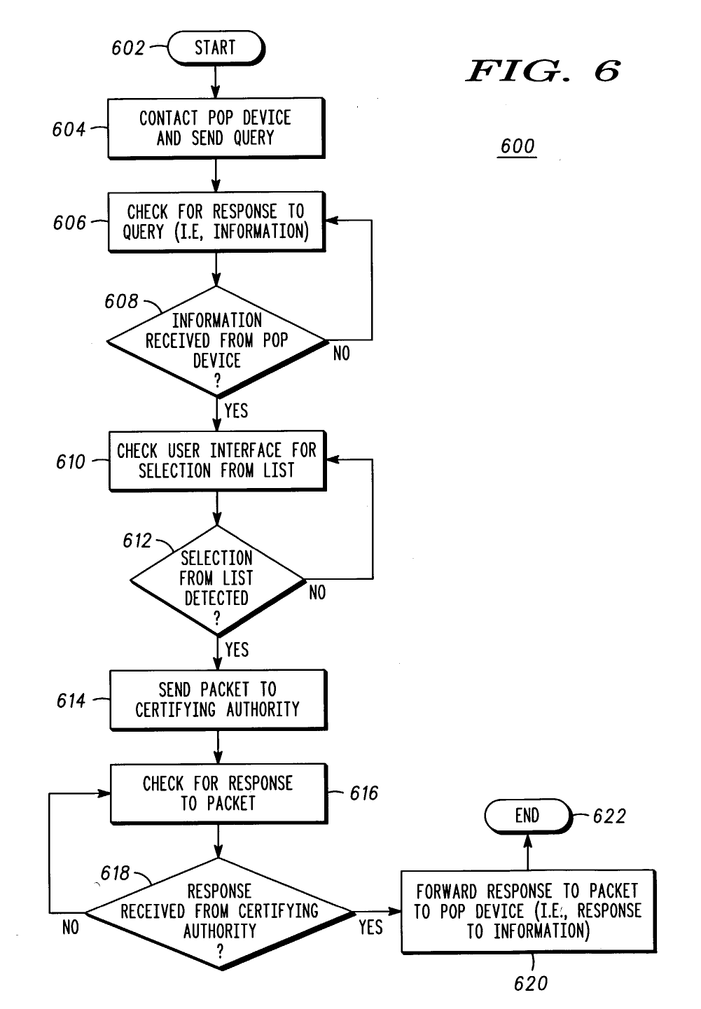

Referring to FIG. 6, there is shown a flow diagram representing a preferred operation 600 of the mobile device 104. The preferred operation 600 of the mobile device 104 begins at step 602. The mechanical input 320 of the mobile device 104 may simply wait until a particular command is received from a user. In the alternative, the short-range communication unit 304 may monitor a proximity of the mobile device 104 for any POP devices 102, particularly POP devices having similar short-range communication units. After beginning the operation 600 at step 602, the short-range communication unit 304 contacts the short-range communication unit 204 of the POP device 102 and sends a query to the unit at step 604. To make sure that communication is possible, the short-range communication unit 304 checks the local airspace to determine whether the POP device 102 (or any POP device) is within proximity of the mobile device 104 via the short-range wireless link 110. As stated above, the proximity is limited by a maximum range of point-to-point transmission of the short-range wireless link 110.

The short-range communication unit 304 checks for any response to the query, i.e., any information received from the POP device 102, at step 606. As stated above, the information includes a POP device ID, available items and/or services, corresponding prices of such items and/or services, and the uniform resource locator (“URL”) or phone number of an appropriate certifying authority 108. If a response to the query is not received initially, then the short-range communication unit 304 continues the check for any response multiple times, if necessary, at step 608. After the response to the query is received, the visual output 318 provides the available items and/or services. The mechanical input 320 then checks any user selection of one or more items and/or services at step 610. The mechanical input 320 continues to wait unit one or more selections are made at step 612.

The longer-range communication unit 306 sends a packet to the certifying authority 108 via the communication network 106 at step 614. In particular, the longer-range communication unit 306 contacts the certifying authority 108 at the URL or phone number provided by the information received from the POP device 102. The packet includes the mobile device ID, the POP device ID, and the total amount requested based on the prices of the selected items and/or services. In the alternative, the price of each selected item and/or service may be included in the packet instead of the total amount.

The longer-range communication unit 306 checks for a response to the packet from the certifying authority 108 at step 616. If necessary, the longer-range communication unit 306 continues the check for any response multiple times at step 618. After a response to the packet is received, the response is forwarded to the POP device 102 at step 620. Although the mobile device 104 may add information to the response to the packet, the mobile device may not modify the response, particularly for an “authorized” response, since the certifying authority 108 has signed the response with a private key. Finally, the processor 302 terminates the operation 600 at step 622, at which point, the processor may return to the beginning of the operation at step 602.

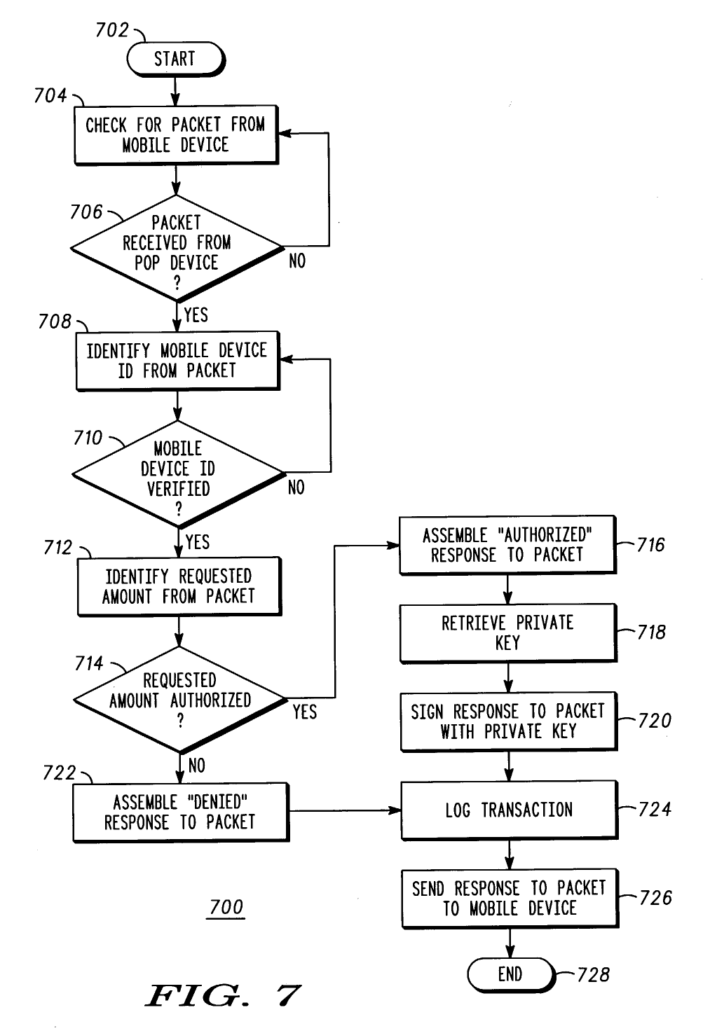

Referring to FIG. 7, there is shown a flow diagram representing a preferred operation 700 of the certifying authority 108. The preferred operation 700 of the certifying authority 108 begins at step 702. The network communication unit 404 of the certifying authority 108 checks for any packet received from a longer-range communication unit 306 of a mobile device 104 at step 704. If necessary, the longer-range communication unit 306 continues the check for any packets multiple times at step 706. If a packet is received from the mobile device 104, then the processor 402 of the certifying authority 108 identifies the mobile device ID from the data in the packet at step 708. The processor 402 then verifies the mobile device ID against a database of financial information for various mobile devices at step 710. In particular, the processor 402 tries to identify financial information corresponding to the mobile device 104 to determine whether to authorize the requested amount and identify the particular financial account to charge the requested amount.

After the processor 402 matches a financial account with the mobile device ID, the processor or the transaction authorization circuit 408 of the certifying authority 10 identifies the amount requested for the transaction based on the data contained within the packet at step 712. The transaction authorization circuit 408 then determines whether to authorize the requested amount based on the financial information corresponding to the mobile device ID at step 714.

If the transaction authorization circuit 408 authorizes the requested amount, then the processor 402 assembles an “authorized” response to the packet at step 716. Next, the processor 402 or the private keys and signature circuit 410 retrieves a private key from the memory unit 406 at step 718. Thereafter, the private keys and signature circuit 410 signs the response to the packet with the private key at step 720. The response is hashed and the hash value signed via public key cryptography using a private key, which is known only to the certifying authority 108. The private keys and signature circuit 410 generates a signature based on the POP device ID, the authorized amount, and the private key. Preferably, the private keys and signature circuit 410 generates the signature based on a sequence number as well as the POP device ID, the authorized amount, and the private key. The sequence number is included in the signature to prevent replaying the same transaction at a subsequent time.

If the transaction authorization circuit 408 does not authorize the requested amount, then the processor 402 merely assembles a “denied” response to the packet at step 722. Although the certifying authority 108 may retrieves a private key from the memory unit 406 and signs the response to the packet with the private key, similar to steps 718 & 720, encryption of the response to the packet is not performed for the preferred operation 700.

After the “denied” response is assembled or the “authorized” response is assembled and signed, the processor 402 logs the transaction into the memory unit 406 at step 724 and sends the response to packet to the mobile device 104 at step 726. Finally, the processor 402 terminates the operation 700 at step 728, at which point, the processor may return to the beginning of the operation at step 702.

For the present invention as described herein, secret keys, i.e., private keys, are not stored in the POP device 102. Also, mutual authentication with the mobile device 104 or financial authorization system, i.e., certifying authority 108, is not needed. In addition, the POP device 102 only performs signature verification and does not need to perform any encryption procedures. Furthermore, the POP device 102 does not need access to a dedicated telephone line or other communications link to interact with the financial authorization system as the purchase message and its associated cost is born by the purchaser via his or her mobile device 104. It is important to note that a single message represents the full value of the transaction and, thus, there are no stored value purses or incremental deductions of points that require the use of secret keys for mutual authentication and transaction non-repudiation.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims. For example, in addition to the transaction information, information about the status of the POP device 102 may be transmitted from the POP device to the certifying authority 108 via the mobile device 104. Such status information may be transferred to a central monitoring service for maintenance and service scheduling of the POP device 102. Examples of the status information includes, but are not limited to, temperature, amount of inventory, and mechanical status of the POP device 102.

What is claimed is:

1. A method for a mobile device of conducting a monetary transaction between a POP device and a certifying authority, the method comprising the steps of:
establishing a first communication with the POP device;
receiving a POP device identification and an amount from the POP device;
establishing a second communication with the certifying authority;
transmitting the POP device identification, the amount, and a mobile device identification to the certifying authority;
receiving the POP device identification, the amount, and a digital signature from the certifying authority; and
forwarding the POP device identification, the amount, and the digital signature to the POP device.

2. The method of claim 1, wherein establishing the second communication includes establishing the second communication having a longer range of communication than the first communication.

3. The method of claim 1, wherein:
establishing the first communication includes establishing a direct link between the mobile device and the POP device; and
establishing the second communication includes establishing an indirect link between the mobile device and the certifying authority through a network infrastructure.

4. The method of claim 1, wherein:
establishing the first communication includes establishing an ad hoc link operable within a particular range from the POP device; and
establishing the second communication includes establishing a network link between the mobile device and a location remote from the POP device.

5. The method of claim 1, wherein receiving the POP device identification and the amount includes receiving a list of dispensable items.

6. The method of claim 5, further comprising:
selecting a particular item from the list of dispensable items; and
determining the amount based on the particular item.

7. The method of claim 1, wherein receiving the POP device identification and the amount includes receiving a list of dispensable services.

8. The method of claim 7, further comprising:
selecting a particular service from the list of dispensable services; and
determining the amount based on the particular service.

9. The method of claim 1, wherein receiving the POP device identification, the amount, and a digital signature includes determining the digital signature based on an encryption key and at least one of the POP device identification, the amount, and a sequence code.

10. A method for a POP device of conducting a monetary transaction between a mobile device and a certifying authority, the method comprising the steps of:
establishing a communication with the mobile device;
sending a POP device identification and an amount to the mobile device;
receiving the POP device identification, the amount, and a digital signature, provided by the certifying authority, from the mobile device; and
dispensing at least one of either a good and a service.

11. The method of claim 10, wherein establishing the communication includes establishing a direct link between the mobile device and the POP device.

12. The method of claim 10, wherein establishing the communication includes establishing an ad hoc link operable within a particular range from the POP device.

13. The method of claim 10, wherein sending the POP device identification and the amount includes sending a list of dispensable items.

14. The method of claim 13, wherein dispensing the at least one of a good or a service includes dispensing a dispensable item selected from the list of dispensable items.

15. The method of claim 10, wherein sending the POP device identification and the amount includes sending a list of dispensable services.

16. The method of claim 15, wherein dispensing the at least one of a good or a service includes dispensing a notice associated with the service.

18. The method of claim 10,
wherein receiving the POP device identification, the amount, and the digital signature includes determining the digital signature based on a private key and at least one of the POP device identification, the amount, and a sequence code; and
further comprising authenticating the response using a public key corresponding to the private key.

19. A system for conducting a monetary transaction comprising:
a POP device having a first transceiver and configured to generate information including a POP device identification and an amount;
a mobile device, associated with a mobile device identification, having a second transceiver being configured to communicate with the first transceiver of the POP device and a third transceiver being configured to communicate with a remote device, the second transceiver to receive the information from the POP device; and
the certifying authority, having a fourth transceiver being configured to communicate with the third transceiver of the mobile device, the fourth transceiver to receive the information and the mobile device identification from the mobile device and transmit the information and a digital signature to the mobile device, and
wherein the mobile device forwards the information and the digital signature to the POP device.

20. The system of claim 19, wherein the third and fourth transceivers have a longer range of communication than the first and second transceivers.

21. The system of claim 19, wherein:
the first and second transceivers provide a direct link between the POP device and the mobile device; and
the third and fourth transceivers provide an indirect link between the mobile device and the certifying authority through a network infrastructure.

22. The system of claim 19, wherein:
the first and second transceivers provide an ad hoc link operable within a particular range from the POP device and the mobile device; and
the third and fourth transceivers provide a network link operable between the mobile device and a location remote from the POP device.

23. The system of claim 19, wherein:
the information includes a list of dispensable items and amounts associated with the dispensable items; and
the mobile device selects a particular item from the list of dispensable items and identifies the amount associated with the particular item selected.

24. The method of claim 19, wherein:
the information includes a list of dispensable services and amounts associated with the services; and
the mobile device selects a particular service from the list of dispensable services and identifies the amount associated with the particular service selected.

25. The method of claim 19, wherein the digital signature is based on an encryption key and at least one of the POP device identification, the amount, and a sequence code.
